(19) United States
(12) Patent Application Publication
(10) Pub. No.: US 2015/0143830 A1
(43) Pub. Date: May 28, 2015

(54) A REFRIGERATOR APPLIANCE AND A METHOD FOR MONITORING A WATER FILTER ASSEMBLY WITHIN THE SAME

(71) Applicant: General Electric Company, Schenectady, NY (US)

(72) Inventors: Andrew Reinhard Krause, La Grange, KY (US); Robert Lee Lewis, JR., Louisville, KY (US)

(73) Assignee: General Electric Company, Schenectady, NY (US)

(21) Appl. No.: 14/088,688

(22) Filed: Nov. 25, 2013

(51) Int. Cl. C02F 1/00; F25D 11/00; F25D 31/00

(52) U.S. Cl. CPC C02F 1/008; F25D 31/002; F25D 11/00; C02F 2307/12
USPC 62/126; 210/739; 137/2

(57) ABSTRACT

Refrigerator appliances and methods for monitoring water filter assemblies within refrigerator appliances are provided. A water filter assembly has a sensor mounted to a filter cartridge of the water filter assembly and a replacement sensor mounted to a replacement filter cartridge of the water filter assembly. A refrigerator appliance has a sensor reader. A method includes detecting the absence of a signal from the sensor at the sensor reader, receiving a signal from the replacement sensor at the sensor reader indicating the presence of the replacement sensor, and providing a signal indicating a purge routine when the receiving step occurs after the detecting step.

### FIELD OF THE INVENTION

The present subject matter relates generally to refrigerator appliances and water filter assemblies for the same.

### BACKGROUND OF THE INVENTION

Certain refrigerator appliances include water filter assemblies for filtering water. Water filter assemblies can filter water entering the refrigerator appliances in order to provide filtered water to various refrigerator appliance components, such as an ice maker and/or a water dispenser. Such filtering can improve a taste and/or an appearance of water within the refrigerator appliances.

Certain water filter assemblies include a manifold and a filter cartridge. The manifold is mounted to a cabinet of the refrigerator appliance and directs unfiltered water into the filter cartridge and filtered water out of the filter cartridge. The filter cartridge includes a filter media, such as an activated carbon block, a pleated polymer sheet, a spun cord material, or a melt blown material. The filter media is positioned within the filter cartridge and filters water passing therethrough.

Over time, the filter media will lose effectiveness. For example, pores of the filter media can become clogged or the filter media can become saturated with contaminants. To insure that the filtering media has not exceeded its filtering capacity, the filtering media is preferably replaced or serviced at regular intervals regardless of its current performance. To permit replacement or servicing of the filter media or the filter cartridge, the filter cartridge is generally removably mounted to the manifold. The filter cartridge may thus be removed from the manifold, and a replacement filter cartridge (which may be a separate filter cartridge or the same filter cartridge after cleaning or otherwise servicing) may be mounted to the manifold.

Many filter cartridges, such as replacement filter cartridges, typically contain air before they are connected in refrigerator appliances. Thus, when a replacement filter cartridge is connected, sputtering, spurting and other flow disruptions can occur during initial water dispensing when water is flowed through the replacement filter cartridge. These flow disruptions can cause negative user impressions. Further, in refrigerator appliances which include hot water dispensing features, such flow disruptions can be dangerous to users. Accordingly, it is generally desirable to purge the replacement filter cartridge by running water therethrough before initial water dispensing.

Many refrigerator appliances include directions in the instruction manual regarding manually purging replacement water filters. However, users typically do not consult the instruction manual and follow these directions when replacing a water filter, such that the above-described issues may persist.

Accordingly, improved methods for monitoring a water filter assembly within a refrigerator appliance would be useful. In particular, method for monitoring a water filter assembly within a refrigerator appliance such that water filter replacement activities are detected and purge routines are initiated by the refrigerator appliance would be advantageous.

### BRIEF DESCRIPTION OF THE INVENTION

In one embodiment, the present disclosure provides a method for monitoring a water filter assembly within a refrigerator appliance, the water filter assembly having a sensor mounted to a filter cartridge of the water filter assembly and a replacement sensor mounted to a replacement filter cartridge of the water filter assembly, the refrigerator appliance having a sensor reader. The method includes detecting the absence of a signal from the sensor at the sensor reader, receiving a signal from the replacement sensor at the sensor reader indicating the presence of the replacement sensor, and providing a signal indicating a purge routine when the receiving step occurs after the detecting step.

In another embodiment, the present disclosure provides a method for monitoring a water filter assembly within a refrigerator appliance, the water filter assembly having a sensor mounted to a filter cartridge of the water filter assembly and a replacement sensor mounted to a replacement filter cartridge of the water filter assembly, the refrigerator appliance having a sensor reader. The method includes establishing signal communication between the sensor and the sensor reader, monitoring the signal communication between the sensor and the sensor reader, searching for a signal communication if the signal communication between the sensor and the sensor reader is lost, and initiating a purge routine when a signal communication between the replacement sensor and the sensor reader is established after the searching step.

In another embodiment, the present disclosure provides a refrigerator appliance. The refrigerator appliance includes a cabinet that defines a chilled chamber for receipt of food articles for storage, and a water filter assembly mounted to the cabinet. The water filter assembly includes a manifold that defines an inlet for receiving unfiltered water and an outlet for directing filtered water out of the water filter assembly, a filter cartridge mounted to the manifold, the cartridge having a filtering media positioned therein for filtering a flow of water through the water filter assembly, and a replacement filter cartridge, the cartridge having a filtering media positioned therein for filtering a flow of water through the water filter assembly. The water filter assembly further includes a sensor mounted to the filter cartridge, and a replacement sensor mounted to the replacement filter cartridge. The refrigerator appliance further includes a sensor reader mounted to the cabinet, and a controller in communication with sensor reader. The controller is configured for establishing signal communication between the sensor and the sensor reader, monitoring the signal communication between the sensor and the sensor reader, searching for a signal communication if the signal communication between the sensor and the sensor reader is lost, and initiating a purge routine when a signal communication between the replacement sensor and the sensor reader is established after searching for the signal communication.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance according to an exemplary embodiment of the present subject matter with refrigerator doors of the refrigerator appliance shown in a closed position.

FIG. 2 provides a front, elevation view of the exemplary refrigerator appliance of FIG. 1 with refrigerator doors of the refrigerator appliance shown in an open position.

FIG. 3 provides a front, elevation view of a water filter assembly according to an exemplary embodiment of the present subject matter.

FIG. 4 provides a rear, perspective view of the exemplary water filter assembly of FIG. 3.

FIG. 5 provides an exploded view of the exemplary water filter assembly of FIG. 3.

FIG. 6 provides a schematic view of certain components of the exemplary refrigerator appliance of FIG. 1 and certain components of the exemplary water filter assembly of FIG. 3.

FIG. 7 illustrates a method for monitoring a water filter assembly within a refrigerator appliance according to an exemplary embodiment of the present subject matter.

FIG. 8 illustrates a method for monitoring a water filter assembly within a refrigerator appliance according to another exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

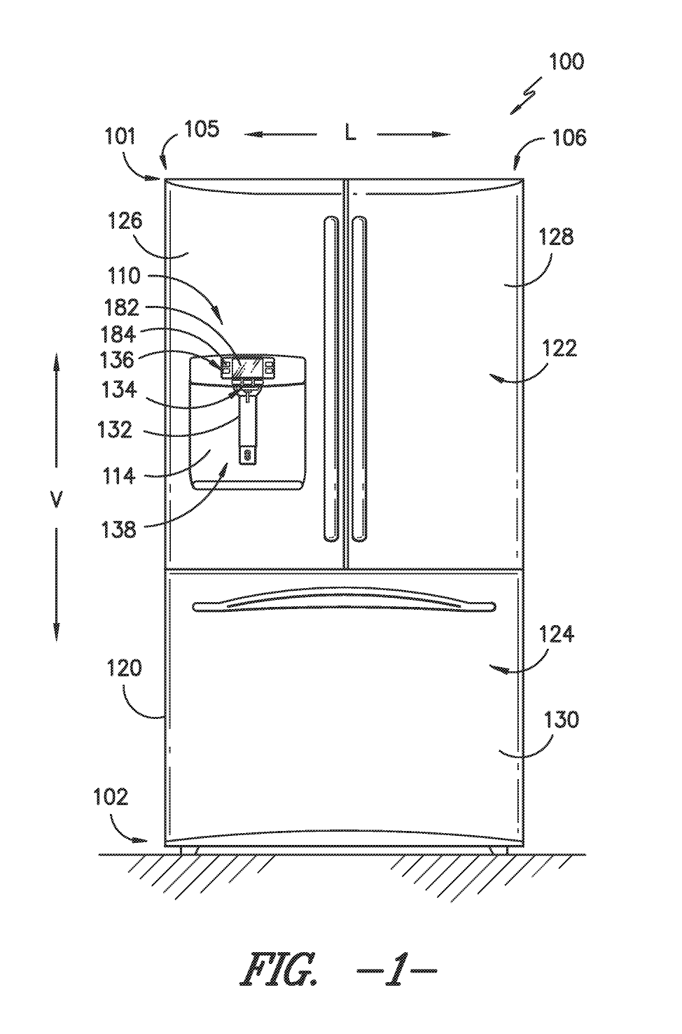

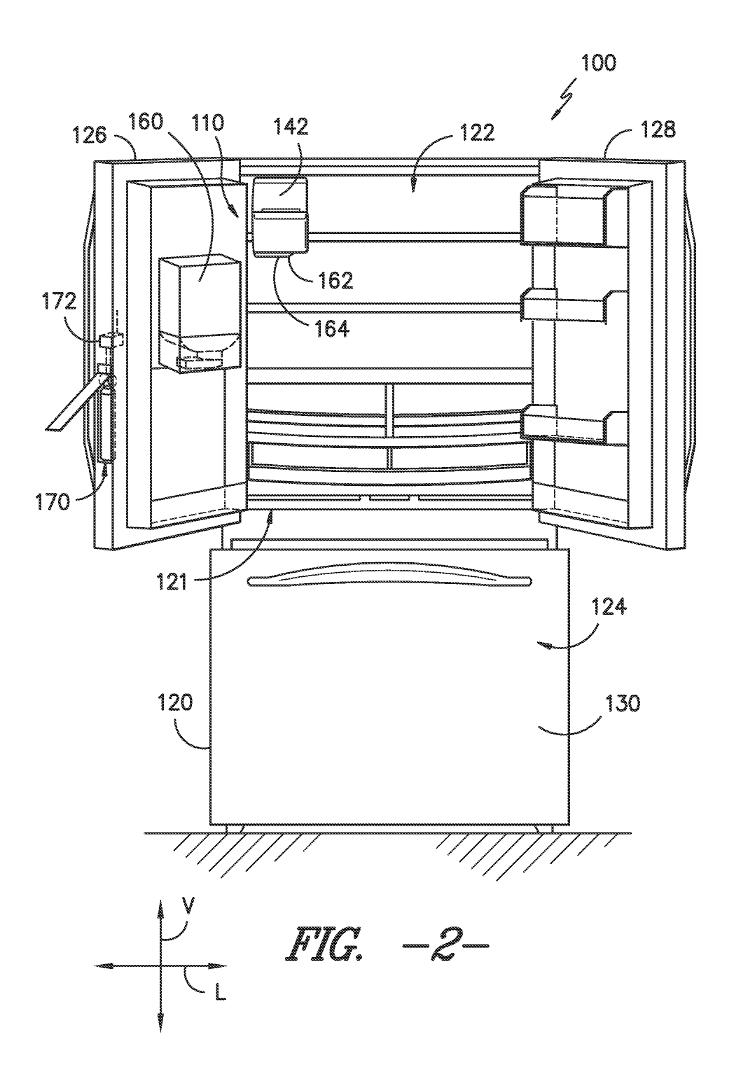

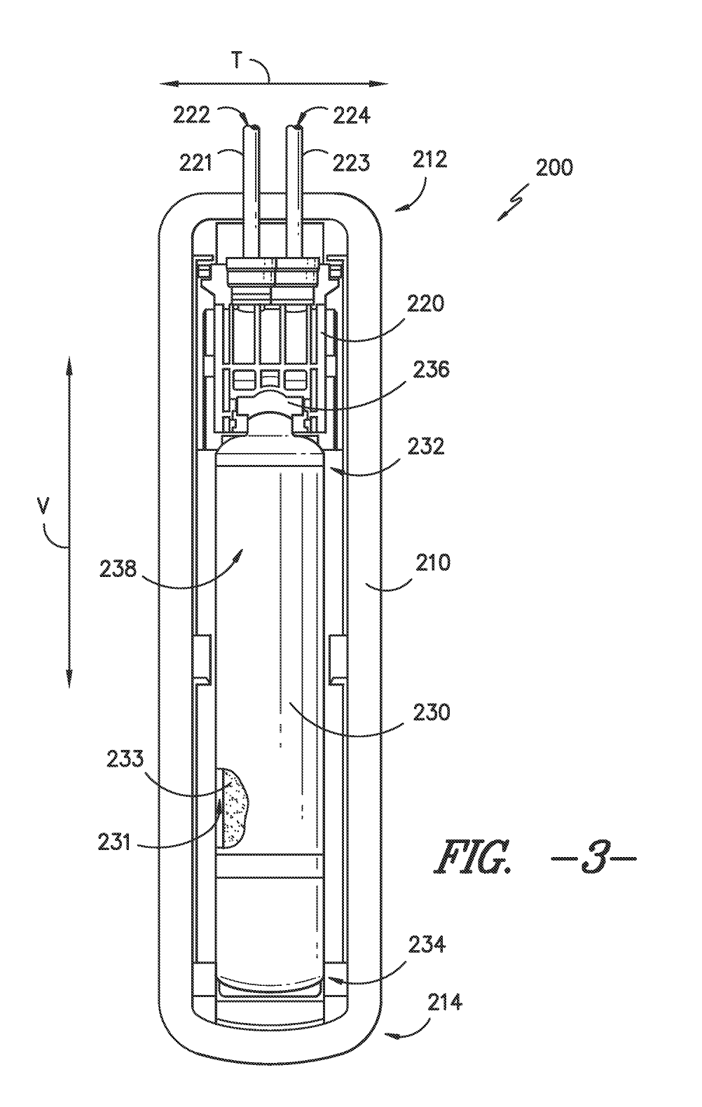

FIG. 1 provides a front, elevation view of a refrigerator appliance 100 according to an exemplary embodiment of the present subject matter. FIG. 2 provides a front, elevation view of refrigerator appliance 100 with refrigerator doors 126 and 128 of refrigerator appliance 100 shown in an open position to reveal a fresh food chamber 122 of refrigerator appliance 100. Refrigerator appliance 100 defines a vertical direction V, a transverse direction T (FIG. 3), and a lateral direction L. The vertical direction V, transverse direction T, and lateral direction L are mutually perpendicular and form an orthogonal direction system. Refrigerator appliance 100 extends between an upper portion 101 and a lower portion 102 along the vertical direction V. Refrigerator appliance 100 also extends between a first side portion 105 and a second side portion 106 along the lateral direction L.

Refrigerator appliance 100 includes a cabinet or housing 120 that defines chilled chambers for receipt of food items for storage. In particular, refrigerator appliance 100 defines fresh food chamber 122 at upper portion 101 of refrigerator appliance 100 and a freezer chamber 124 arranged below fresh food chamber 122 on the vertical direction V, e.g., at lower portion 102 of refrigerator appliance 100. As such, refrigerator appliance 100 is generally referred to as a bottom mount refrigerator appliance. However, using the teachings disclosed herein, one of skill in the art will understand that the present subject matter may be used with other types of refrigerator appliances (e.g., side-by-side style or top mount style) or a freezer appliance as well. Consequently, the description set forth herein is for illustrative purposes only and is not intended to limit the present subject matter in any aspect.

Refrigerator doors 126 and 128 are rotatably hinged to an edge of housing 120 for accessing fresh food chamber 122. In particular, housing 120 defines an opening 121. Opening 121 of housing 120 permits access to fresh food chamber 122 of housing 120. Refrigerator doors 126 and 128 are positioned at opening 121 of housing 120 and permit selective access to fresh food chamber 122 of housing 120 through opening 121 of housing 120, e.g., by rotating between the open and closed positions. A freezer door 130 is arranged below refrigerator doors 126 and 128 for accessing freezer chamber 124. Freezer door 130 is coupled to a freezer drawer (not shown) slidably mounted within freezer chamber 124.

Refrigerator appliance 100 also includes a dispensing assembly 110 for dispensing water and/or ice. Dispensing assembly 110 includes a dispenser 114 positioned on or mounted to an exterior portion of refrigerator appliance 100, e.g., on refrigerator door 126. Dispenser 114 includes a discharging outlet 134 for accessing ice and water. A sensor 132, such as an ultrasonic sensor, is mounted below discharging outlet 134 for operating dispenser 114. In alternative exemplary embodiments, any suitable actuator may be used to operate dispenser 114. For example, dispenser 114 can include a paddle or button rather than sensor 132. A user interface panel 136 is provided for controlling the mode of operation. For example, user interface panel 136 includes a water dispensing button (not labeled) and an ice-dispensing button (not labeled) for selecting a desired mode of operation such as crushed or non-crushed ice.

Discharging outlet 134 and sensor 132 are an external part of dispenser 114 and are mounted in a dispenser recess 138 defined in an outside surface of refrigerator door 126. Dispenser recess 138 is positioned at a predetermined elevation convenient for a user to access ice or water and enabling the user to access ice without the need to bend-over and without the need to access freezer chamber 124. In the exemplary embodiment, dispenser recess 138 is positioned at a level that approximates the chest level of a user.

Turning now to FIG. 2, certain components of dispensing assembly 110 are illustrated. Dispensing assembly 110 includes an insulated housing 142 mounted within fresh food chamber 122. Due to the insulation which encloses insulated housing 142, the temperature within insulated housing 142 can be maintained at levels different from the ambient temperature in the surrounding fresh food chamber 122.

Insulated housing 142 is constructed and arranged to operate at a temperature that facilitates producing and storing ice. More particularly, insulated housing 142 contains an ice maker (not shown) for creating ice and feeding the same to a container 160 that is mounted on refrigerator door 126. As illustrated in FIG. 2, container 160 is placed at a vertical position on refrigerator door 126 that will allow for the receipt of ice from a discharge opening 162 located along a bottom edge 164 of insulated housing 142. As refrigerator door 126 is closed or opened, container 160 is moved in and out of position under insulated housing 142.

Refrigerator appliance 100 also includes a water filter assembly 170. Water filter assembly 170 can filter water from a water supply (not shown), such as a municipal water source or a well. Water filter assembly 170 can remove contaminants and other undesirable substances from water passing therethrough. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

Water filter assembly 170 is mounted to housing 120. In particular, water filter assembly 170 is mounted to refrigerator door 126 in the exemplary embodiment shown in FIG. 2. However, it should be understood that water filter assembly 170 can be positioned at any other suitable location within refrigerator appliance 100 in alternative exemplary embodiments. For example, water filter assembly 170 may be mounted to refrigerator door 128, to housing 120 within fresh food chamber 122, or to housing 120 below freezer chamber 124 in alternative exemplary embodiments. Thus, the position of water filter assembly 170 shown in FIG. 2 is not intended to limit the present subject matter in any aspect and is provided by way of example only.

Refrigerator appliance 100 also includes a valve 172 as schematically shown in FIG. 2. Valve 172 is configured for regulating a flow of water to water filter assembly 170. In particular, valve 172 can selectively shift between a closed position and an open position. Valve 172 permits the flow of water to water filter assembly 170 in the open position. Thus, with valve 172 in the open position, water for filtering is supplied to water filter assembly 170. Conversely, valve 172 obstructs or blocks the flow of water to water filter assembly 170 in the closed position. Thus, with valve 172 in the closed position, water for filtering is not supplied to water filter assembly 170 or is supplied to water filter assembly 170 in an insubstantial volume. In such a manner, valve 172 can regulate the flow of water to water filter assembly 170 by shifting between the open and closed positions.

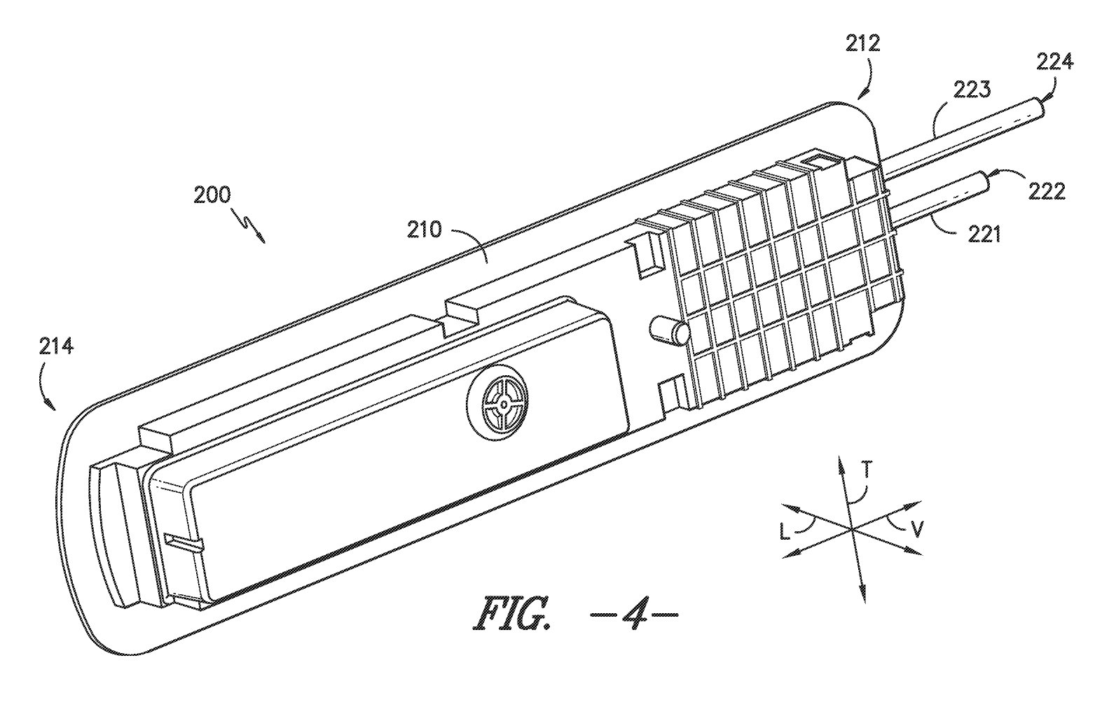

FIG. 3 provides a front, elevation view of a water filter assembly 200 according to an exemplary embodiment of the present subject matter. FIG. 4 provides a rear, perspective view of water filter assembly 200. Water filter assembly 200 can be used in any suitable refrigerator appliance. For example, water filter assembly 200 may be used in refrigerator appliance 100 (FIG. 2) as water filter assembly 170 (FIG. 2). As discussed in greater detail below, water filter assembly 200 is configured for filtering water passing therethrough. In such a manner, water filter assembly 200 can provide filtered water to various components of refrigerator appliance 100, such as dispensing assembly 110 or the ice maker (not shown) within insulated housing 142.

As may be seen in FIGS. 3 and 4, water filter assembly 200 includes a casing 210. Casing 210 extends between a top portion 212 and a bottom portion 214, e.g., along the vertical direction V. Casing 210 can be mounted to any suitable portion of refrigerator appliance 100 in order to mount water filter assembly 200 to refrigerator appliance 100. For example, casing 210 may be mounted to refrigerator door 126 or housing 120. In particular, casing 210 may be encased within or engage insulating foam (not shown) of housing 120 to mount water filter assembly 200 to refrigerator appliance 100.

Water filter assembly 200 also includes a manifold 220. Manifold 220 is mounted to casing 210, e.g., at or proximate top portion 212 of casing 210. Manifold 220 is configured for receiving unfiltered water and directing filtered water out of water filter assembly 200. In particular, manifold 220 includes an inlet conduit 221 that defines an inlet 222. Inlet 222 receives unfiltered water, e.g., from a water source (not shown) such as a municipal water supply or a well. Manifold 220 also includes an outlet conduit 223 that defines an outlet 224. Outlet 224 directs filtered water out of water filter assembly 200. Thus, manifold 220 receives unfiltered water at inlet 222. Such unfiltered water passes through water filter assembly 200 and exits manifold 220 at outlet 224 as filtered water.

As shown in FIG. 3, water filter assembly 200 includes a filter canister or filter cartridge 230, and may further include a replacement filter cartridge 230, for filtering unfiltered water received at inlet 222 of manifold 220. It should be understood that filter cartridges 230 and replacement filter cartridges 230 as discussed herein generally include the same components and may be mounted within water filter assembly 200 in the same manner. Accordingly, descriptions herein of filter cartridges 230 herein may equally apply to replacement filter cartridges 230. Filter cartridge 230 filters water passing through water filter assembly 200. Filter cartridge 230 extends between a top portion 232 and a bottom portion 234, e.g., along the vertical direction V. A connection 236 of filter cartridge 230 is positioned at or proximate top portion 232 of filter cartridge 230. Connection 236 of filter cartridge 230 is configured for engaging manifold 220, e.g., in order to removably mount filter cartridge 230 to manifold 220.

Connection 236 of filter cartridge 230 also places filter cartridge 230 in fluid communication with manifold 220 when filter cartridge 230 is mounted to manifold 220. Thus, filter cartridge 230 can receive unfiltered water from inlet 222 of manifold 220 at connection 236 and direct such unfiltered water into a chamber 231 when filter cartridge 230 is mounted to manifold 220. Water within chamber 231 can pass through a filtering media 233 positioned within chamber 231 and can exit chamber 231 as filtered water. In particular, connection 236 of filter cartridge 230 can direct filtered water out of chamber 231 to outlet 224 of manifold 220 when filter cartridge 230 is mounted to manifold 220. In such a manner, filtering media 233 of filter cartridge 230 can filter a flow of water through water filter assembly 200. Such filtering can improve taste and/or safety of water.

Filtering media 233 can include any suitable mechanism for filtering water within water filter assembly 200. For example, filtering media 233 may include an activated carbon block, a reverse osmosis membrane, a pleated polymer or cellulose sheet, or a melt blown or spun cord media. As used herein, the term “unfiltered” describes water that is not filtered relative to filtering media 233. However, as will be understood by those skilled in the art, water filter assembly 200 may include additional filters that filter water entering chamber 231. Thus, “unfiltered” may be filtered relative to other filters but not filtering media 233.

As will be understood by those skilled in the art, filtering media 233 of filter cartridge 230 can lose efficacy over time. Thus, a user can replace filtering cartridge and/or filtering media 233 of filter cartridge 230 at regular intervals or after a certain volume of water has passed through filter cartridge 230. To replace filtering cartridge and/or filtering media 233 of filter cartridge 230, the user can remove or disconnect filter cartridge 230 from manifold 220 and insert or mount a replacement filter cartridge 230 or filtering media 233 of filter cartridge 230.

As discussed, filter cartridges 230 and replacement filter cartridges 230 may contain air therein, such as in the chamber 231, before they are mounted to manifold 220 and within casing 210 of a refrigerator appliance 100. Accordingly, the present disclosure is further directed to methods and apparatus for monitoring water filter assemblies 200 which facilitate purging this air from the filter cartridges 230 when they are initially so mounted. Water filter assembly 200 thus advantageously includes various features for detecting the absence of filter cartridges 230 and the presence of replacement filter cartridges 230.

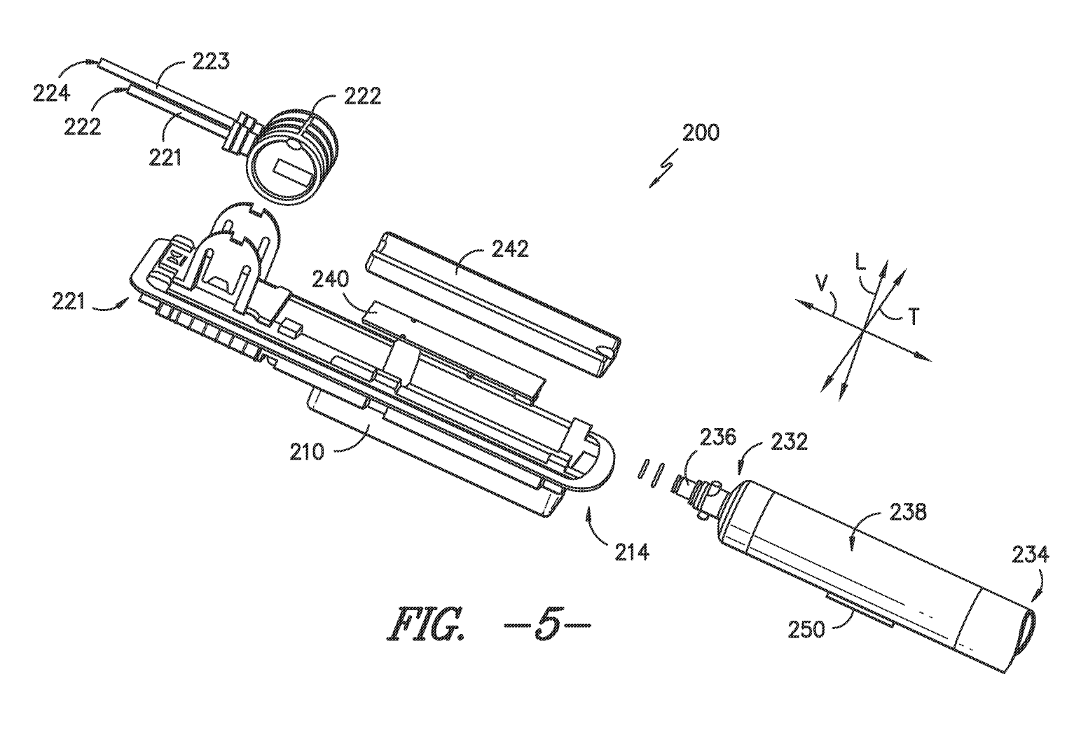

FIG. 5 provides an exploded view of water filter assembly 200. As may be seen in FIG. 5, water filter assembly 200 includes a sensor 250. In exemplary embodiments, the sensor 250 is a radio frequency identification tag or RFID tag. Alternatively, the sensor 250 may be, for example, a proximity sensor or another suitable switch, electrical hardwired or wireless signal generator, etc., which can facilitate sensing the presence or absence of the sensor 250. Sensor 250 is mounted to filter cartridge 230. Accordingly, a filter cartridge 230 may include a sensor 250, and a replacement filter cartridge 230 may include a replacement sensor 250. In particular, sensor 250 and replacement sensor 250 are positioned at or on an outer surface 238 of filter cartridge 230 and replacement filter cartridge 230, respectively. Water filter assembly 200 also includes a sensor reader 240, which in exemplary embodiments is a radio frequency identification reader or RFID reader. Alternatively, sensor 240 may be a mating switch, signal reader, etc. which can sense the presence or absence of the sensor 250. Sensor reader 240 is mounted to casing 210 and protected behind a cover 242. Sensor reader 240 is also positioned proximate sensor 250 when the filter cartridge 230 is mounted within casing 210, and proximate replacement sensor 250 when the replacement sensor 250 is mounted within the casing 210.

Sensor reader 240 is configured for receiving a signal from sensor 250 and replacement sensor 250. Thus, sensor reader 240 and sensor/replacement sensor 250 can be in signal communication with each other. As an example, sensor/replacement sensor 250 may be a passive RFID tag. Thus, sensor reader 240 can receive a radio signal from such RFID tag 250 in response to a query or request signal from RFID reader 240. In particular, such RFID tag/replacement RFID tag 250 can generate or transmit the response radio signal utilizing energy transmitted, e.g., wirelessly, to RFID tag/replacement RFID tag 250 from RFID reader 240 via the query or request signal from RFID reader 240. Thus, RFID tag 250 need not include a battery or other power source in order to generate or transmit the response radio signal. As another example, RFID tag/replacement RFID tag 250 can include a battery or be connected to a suitable power source, and RFID tag/replacement RFID tag 250 can continuously or intermittently generate or transmit a signal that RFID reader 240 can receive. As will be understood, RFID reader 240 and RFID tag/replacement RFID tag 250 can have any other suitable setup or configuration for placing RFID reader 240 and RFID tag/replacement RFID tag 250 in signal communication with each other. Thus, RFID reader 240 may be passive or active, and RFID tag/replacement RFID tag 250 may be passive or active depending upon the desired setup of water filter assembly 200.

As will be understood by those skilled in the art, signal communication between RFID reader 240 and RFID tag/replacement RFID tag 250 is affected by a variety of factors. For example, RFID reader 240 and RFID tag/replacement RFID tag 250 are separated by a particular distance within water filter assembly 200. Signal communication between RFID reader 240 and RFID tag/replacement RFID tag 250 can be limited or terminated if the distance between RFID reader 240 and RFID tag/replacement RFID tag 250 is increased. Similarly, signal communication between RFID reader 240 and RFID tag/replacement RFID tag 250 is stronger when RFID reader 240 and RFID tag/replacement RFID tag 250 face each other rather than being perpendicularly oriented to each other. Thus, if an orientation between an antenna (not shown) of RFID reader 240 and an antenna (not shown) of RFID tag/replacement RFID tag 250 is adjusted or changed, signal communication between RFID reader 240 and RFID tag/replacement RFID tag 250 can be limited or terminated.

RFID reader 240 and RFID tag/replacement RFID tag 250 can also be tuned such that signal communication between RFID reader 240 and RFID tag/replacement RFID tag 250 is established with a particular transmission media, such as air, disposed between RFID reader 240 and RFID tag/replacement RFID tag 250. Thus, signal communication between RFID reader 240 and RFID tag/replacement RFID tag 250 can be terminated if the transmission media changes and another material is positioned between RFID reader 240 and RFID tag/replacement RFID tag 250. For example, if water or a solid object positioned between RFID reader 240 and RFID tag/replacement RFID tag 250, signal communication between RFID reader 240 and RFID tag/replacement RFID tag 250 can be terminated or disrupted. In particular, liquids, such as water, can absorb radio waves and thereby terminate or disrupt signal communication between RFID reader 240 and RFID tag/replacement RFID tag 250. Similarly, solids, such as a metal, can shield or reflect radio waves and thereby terminate or disrupt signal communication between RFID reader 240 and RFID tag/replacement RFID tag 250. As described in greater detail below, when signal communication between RFID reader 240 and RFID tag/replacement RFID tag 250 is lost or terminated, water filter assembly 200 may be malfunctioning, e.g., may be leaking.

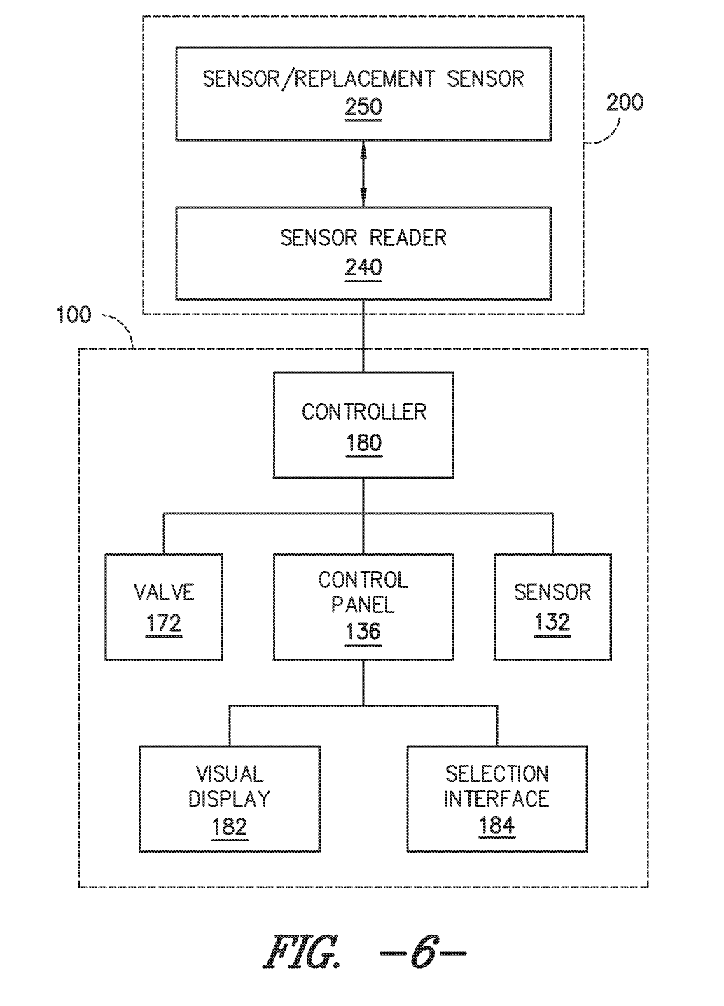

FIG. 6 provides a schematic view of certain components of refrigerator appliance 100 and certain components of water filter assembly 200. Operation of the refrigerator appliance 100 and water filter assembly 200 can be regulated by a controller 180 that is operatively coupled to various components of refrigerator appliance 100 and water filter assembly 200, such as user interface panel 136, sensor 132, valve 172, sensor reader 240, etc. For example, in response to user manipulation of user interface panel 136, controller 180 operates various components of the refrigerator appliance 100 and water filter assembly 200.

Controller 180 may include a memory and one or more microprocessors, CPUs or the like, such as general or special purpose microprocessors operable to execute programming instructions or micro-control code associated with operation of refrigerator appliance 100 and water filter assembly 200. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 180 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 180 may be positioned in a variety of locations throughout refrigerator appliance 100. In the illustrated exemplary embodiment of FIG. 1, controller 180 may be located within the control panel area of refrigerator door 126. In such an embodiment, input/output (“I/O”) signals may be routed between controller 180 and various operational components of refrigerator appliance 100 and water filter assembly 200. User interface panel 136 may be in communication with controller 180 via one or more signal lines or shared communication busses.

As discussed above, controller 180 is in communication with sensor reader 240. Controller 180 is configured for establishing signal communication between sensor/replacement sensor 250 and sensor reader 240. For example, controller 180 can activate sensor reader 240 such that sensor reader 240 queries sensor/replacement sensor 250 by sending a request signal to sensor/replacement sensor 250. In response to the request signal, sensor/replacement sensor 250 can generate or transmit a response signal that is received at sensor reader 240. In such a manner, controller 180 can establish signal communication between sensor reader 240 and sensor/replacement sensor 250.

Controller 180 is also configured for monitoring the signal communication between sensor/replacement sensor 250 and sensor reader 240. For example, controller 180 can continuously or intermittently operate sensor reader 240 such that sensor reader 240 queries sensor/replacement sensor 250 by sending a request signal to sensor/replacement sensor 250. If sensor/replacement sensor 250 receives the request signal from sensor reader 240, sensor/replacement sensor 250 can generate or transmit a response signal that is received at sensor reader 240 in response to the request signal. If sensor reader 240 receives the response signal from sensor/replacement sensor 250, controller 180 can determine that sensor reader 240 and sensor/replacement sensor 250 are in signal communication with each other. Conversely, if sensor reader 240 does not receive the response signal from sensor/replacement sensor 250, controller 180 can determine that sensor reader 240 and sensor/replacement sensor 250 are not in signal communication with each other. In such a manner, controller 180 can monitor the signal communication between sensor/replacement sensor 250 and sensor reader 240.

Controller 180 may further be configured for searching for a signal communication if a signal communication between the sensor reader 240 and a sensor/replacement sensor 250 is lost. For example, as discussed, controller 180 can continuously or intermittently operate sensor reader 240 such that sensor reader 240 queries sensor/replacement sensor 250 by sending a request signal to sensor/replacement sensor 250. If sensor reader 240 does not receive a response signal from sensor/replacement sensor 250, controller 180 can determine that sensor reader 240 and sensor/replacement sensor 250 are not in signal communication with each other. This lack of response signal can indicate a loss of signal communication. If this occurs, controller 180 can activate sensor reader 240 such that sensor reader 240 continuously or intermittently sends a request signal, in an effort to re-establish signal communication between sensor reader 240 and sensor/replacement sensor 250.

Accordingly, sensors 250, replacement sensors 250, and sensor reader 240 can be utilized to determine when a filter cartridge 230 has been replaced, and a purge routine can be initiated for the replacement filter cartridge 230 when this replacement is made. For example, as discussed, controller 180 may establish and monitor the signal communication between a sensor 250 and the sensor reader 240. Such signal communication indicates the presence of the sensor 250, and thus the presence of the associated filter cartridge 230. Loss of the signal communication indicates the absence of the sensor 250, and thus the presence of the associated filter cartridge 230. Further, establishing of a signal communication after a signal communication has been lost may indicate the presence of a replacement sensor 230, and thus the presence of the associated replacement filter cartridge 230. A purge routine can then be initiated to purge air from the replacement filter cartridge 230 before any further use of liquid dispensing functions of the refrigerator appliance 100.

Purge routine generally provides a flow of water to the replacement filter cartridge 230, in order to purge air from the cartridge 230. For example, valve 172 may be utilized and controlled by controller 180 to perform the purge routine and provide such flow of water. As discussed, valve 172 may be selectively shifted between a closed position and an open position. Upon initiation of a purge routine by the controller 180 due to re-establishing of a signal communication as discussed above, the valve 172 may be adjusted, such as by the controller 180, to the open position. Thus, a flow of water may be provided to the replacement filter cartridge 230 to purge air from the cartridge 230. Such flow of water may be provided for, for example, a predetermined period of time, after which valve 172 may be selectively shifted to the closed position and the purge routine may be completed. Upon completion of the purge routine, normal operation of the refrigerator appliance 100, such as including normal liquid dispensing functions, may be commenced/recommenced.

In some embodiments, the purge routine is performed automatically after the signal communication between the sensor reader 240 and replacement sensor 250 is established. For example, upon re-establishment of this signal communication, the controller 180 may automatically, without any user input, initiate the purge routine. Alternatively, the purge routine may be performed based on a user input after the signal communication is re-established. For example, user interface panel 136 of refrigerator appliance may include a visual display 182 and selection interfaces 184 (which may for example be physical buttons or touchscreen locations on the visual display). Visual display 182 may, for example, be a screen which displays various indicia or text as required, or a light or other suitable indicator. When signal communication is re-established, the controller 180 may cause the visual display 182 to display a signal indicating that a purge routine is required. A user may select, for example, a selection interface 184 associated with initiation of the purge routine to initiate the purge routine.

As discussed, in some embodiments, liquid dispensing functions of the refrigerator appliance 100 may be disabled until the purge routine is completed. Liquid dispensing functions may generally be any functions of the refrigerator appliance that require the use of a water filter assembly 170, including dispensing hot or cold water, icemaking, etc., such as those liquid dispensing functions discussed herein. Such liquid dispensing functions may, after the purge routine is completed, by re-enabled.

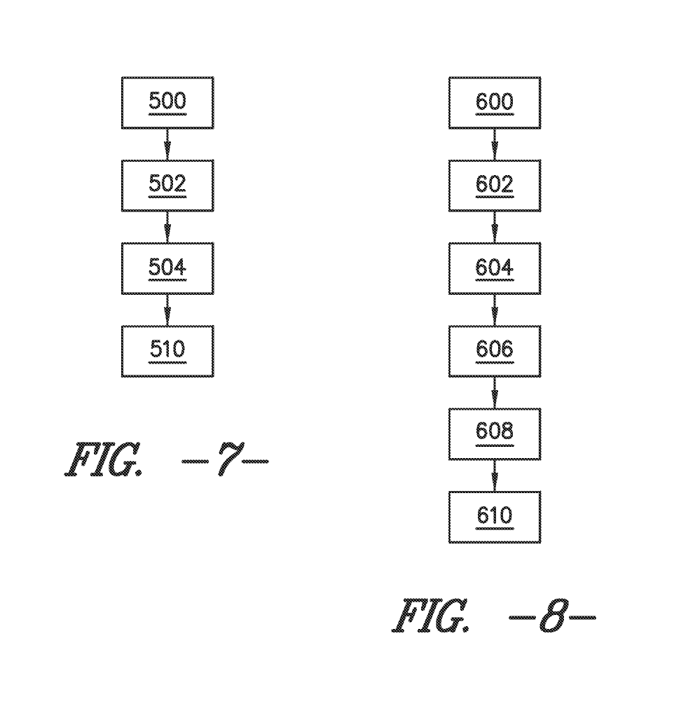

The present disclosure is further directed to methods for monitoring a water filter assembly 200 within a refrigerator appliance 100. Such methods may be utilized to detect the replacement of a filter cartridge 230 with a replacement filter cartridge 230, and to perform a purge routine to purge air from the replacement filter cartridge 230 when installed. Referring now to FIG. 7, a method may include, for example, the step 500 of detecting the absence of a signal from a sensor 250 at a sensor reader 240. Such absence may, for example, be detected by the sensor reader 240 when establishing or monitoring signal communication between the sensor 250 and sensor reader 240. A method may further include, for example, the step 502 of receiving a signal from a replacement sensor 250 at the sensor reader 240 indicating the presence of the replacement sensor 250. Such signal may, for example, be received by the sensor reader 240 when searching for a signal communication. A method may further include, for example, the step 504 of providing a signal indicating a purge routine when the receiving step 502 occurs after the detecting step 500. Such signal may thus, for example, be provided after signal communication is re-established, such as between a replacement sensor 250 and the sensor reader 240. The signal may, for example, be provided by the sensor reader 240 to the controller 180.

In exemplary embodiments, a method may include, for example, the step 510 of permitting a flow of water to the water filter assembly 200 based on the providing step 504. For example, valve 172 may be actuated to an open position for a predetermined time period to provide such flow of water, as discussed above, when the purge routine signal is provided, such by the controller 180 upon signal communication re-establishment. In some embodiments, as discussed above, such permitting step 510 may occur automatically based on the providing step 504. In other embodiments, such permitting step 510 may occur based on a user input to the user interface panel 136.

In further exemplary embodiments, as discussed above, liquid dispensing functions of the refrigerator appliance 100 may be disabled, such as when the providing step 504 occurs and until the permitting step 510 is complete.

Referring now to FIG. 8, in other embodiments, a method may include, for example, the step 600 of establishing signal communication between a sensor 250 and a sensor reader 240, as discussed above. A method may further include the step 602 of monitoring the signal communication between the sensor 250 and the sensor reader 240, as discussed above. A method may further include, for example, the step 604 of searching for a signal communication if the signal communication between the sensor 250 and the sensor reader 240 is lost, as discussed above.

A method may further include, for example, the step 606 of initiating a purge routine when a signal communication between a replacement sensor 250 and the sensor reader 240 is established after the searching step 604, as discussed above. For example, in some embodiments, such step 606 may include the step 608 of permitting a flow of water to the water filter assembly 200, as discussed above. Such step 608 may in exemplary embodiments include the step 610 of actuating a valve 172 to an open position for a predetermined time period. Further, such step 608 may, in some embodiments, occur automatically based on the initiating step 606. In other embodiments, such step 608 may occur based on a user input after the initiating step, as discussed above.

In further exemplary embodiments, as discussed above, liquid dispensing functions of the refrigerator appliance 100 may be disabled, such as when the initiating step 606 occurs and until the permitting step 608 is complete.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for monitoring a water filter assembly within a refrigerator appliance, the water filter assembly having a sensor mounted to a filter cartridge of the water filter assembly and a replacement sensor mounted to a replacement filter cartridge of the water filter assembly, the refrigerator appliance having a sensor reader, the method comprising:
detecting the absence of a signal from the sensor at the sensor reader;
receiving a signal from the replacement sensor at the sensor reader indicating the presence of the replacement sensor;
providing a signal indicating a purge routine when the receiving step occurs after the detecting step.

2. The method of claim 1, further comprising permitting a flow of water to the water filter assembly based on the providing step.

3. The method of claim 2, wherein the permitting step occurs automatically based on the providing step.

4. The method of claim 2, wherein the signal indicating the purge routine is provided to a user interface panel, and wherein the permitting step occurs based on a user input to the user interface panel.

5. The method of claim 2, wherein a liquid dispensing function of the refrigerator appliance is disabled when the providing step occurs until the permitting step is complete.

6. The method of claim 2, wherein the permitting step comprises actuating a valve of the refrigerator appliance to an open position for a predetermined time period.

7. The method of claim 1, wherein the sensor is an RFID tag, the replacement sensor is a replacement RFID tag, and the sensor reader is an RFID reader.

8. A method for monitoring a water filter assembly within a refrigerator appliance, the water filter assembly having a sensor mounted to a filter cartridge of the water filter assembly and a replacement sensor mounted to a replacement filter cartridge of the water filter assembly, the refrigerator appliance having a sensor reader, the method comprising:
establishing signal communication between the sensor and the sensor reader;
monitoring the signal communication between the sensor and the sensor reader;
searching for a signal communication if the signal communication between the sensor and the sensor reader is lost;
initiating a purge routine when a signal communication between the replacement sensor and the sensor reader is established after the searching step.

9. The method of claim 8, wherein the initiating step comprises permitting a flow of water to the water filter assembly.

10. The method of claim 9, wherein the permitting step occurs automatically based on the initiating step.

11. The method of claim 9, wherein the permitting step occurs based on a user input after the initiating step.

12. The method of claim 9, wherein a liquid dispensing function of the refrigerator appliance is disabled when the initiating step occurs until the permitting step is complete.

13. The method of claim 9, wherein the permitting step comprises actuating a valve of the refrigerator appliance to an open position for a predetermined time period.

14. The method of claim 8, wherein the sensor is an RFID tag and the sensor reader is an RFID reader.

15. A refrigerator appliance, comprising:
a cabinet that defines a chilled chamber for receipt of food articles for storage;
a water filter assembly mounted to the cabinet, the water filter assembly comprising
a manifold that defines an inlet for receiving unfiltered water and an outlet for directing filtered water out of the water filter assembly;
a filter cartridge mounted to the manifold, the cartridge having a filtering media positioned therein for filtering a flow of water through the water filter assembly;
a replacement filter cartridge, the cartridge having a filtering media positioned therein for filtering a flow of water through the water filter assembly;
a sensor mounted to the filter cartridge; and
a replacement sensor mounted to the replacement filter cartridge;
a sensor reader mounted to the cabinet; and
a controller in communication with sensor reader, the controller configured for:
establishing signal communication between the sensor and the sensor reader;
monitoring the signal communication between the sensor and the sensor reader;
searching for a signal communication if the signal communication between the sensor and the sensor reader is lost;
initiating a purge routine when a signal communication between the replacement sensor and the sensor reader is established after searching for the signal communication.

16. The refrigerator appliance of claim 15, wherein the sensor of the water filter assembly is positioned on an outer surface of the filter cartridge of the water filter assembly.

17. The refrigerator appliance of claim 15, wherein the replacement sensor of the water filter assembly is positioned on an outer surface of the replacement filter cartridge of the water filter assembly.

18. The refrigerator appliance of claim 15, wherein the cabinet defines an opening for permitting access to the chilled chamber of the cabinet, the cabinet having a door positioned at the opening of the cabinet for permitting selective access to the chilled chamber of the cabinet through the opening of the cabinet, the sensor reader mounted to the door of the cabinet.

19. The refrigerator appliance of claim 15, wherein the sensor is an RFID tag, the replacement sensor is a replacement RFID tag, and the sensor reader is an RFID reader.

20. The refrigerator appliance of claim 15, further comprising a valve for regulating the flow of water to the water filter assembly, the valve configured for selectively shifting between a closed position and an open position, the valve permitting the flow of water to the water filter assembly in the open position, the valve obstructing the flow of water to the water filter assembly in the closed position, the controller in communication with the valve, the controller configured for adjusting the valve to the open position when the purge routine is initiated.
